(19) United States
(12) Patent Application Publication
(10) Pub. No.: US 2007/0212495 A1
(43) Pub. Date: Sep. 13, 2007

(54) Intumescent coatings

(76) Inventor: Charles Anthony Nuzzo, Fredon, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/450,574

(22) Filed: Jun. 9, 2006

Related U.S. Application Data
(60) Provisional application No. 60/780,112, filed on Mar. 8, 2006.

(51) Int. Cl. B05D 7/00

(52) U.S. Cl. 427/421.1

(57) ABSTRACT

A method of providing a thermal barrier between a fire and a combustible substrate, such as polyurethane foam, is provided. The method comprises the step of applying at least one coat of thin-film intumescent coating to the surface of the combustible substrate. The coating may be applied to the surface of the foam by any conventional means such as rolling or brushing, but is preferably spray applied with an airless sprayer. The thin-film intumescent coating may be solvent based but is preferably water based and preferably comprises polyvinyl acetate resins and inorganic fillers. The coating is typically applied range from 1-500 mils thick. The polyurethane foam is preferably spray-applied polyurethane foam with a density in the range of 0.5-3.2 lbs.

### CROSS REFERENCE TO RELATED APPLICATION

This application claims the benefit of U.S. Provisional Patent Application No. 60/780,112 filed Mar. 8, 2006, the entirety of which is hereby incorporated by reference into this application.

### BACKGROUND OF THE INVENTION

1. Field of the Invention

The present invention relates to thin-film based intumescent fire protection coatings and polyurethane insulation.

2. Description of Related Art

The versatility of rigid and/or spray applied polyurethane foam makes it suitable for an extensive range of insulation applications including residential housing, commercial offices, industrial, aviation and aerospace, and institutional buildings. Board and block are highly versatile insulants suitable for use in many construction applications, including flat and pitched roofs, cavity walls, floors, internal linings, composite decks, aircraft cavities, hulls, tunnels, mineshaft ducts, pipes and tanks.

Building codes generally require an approved thermal barrier on the habitable side of a structure between the interior of the structure and the polyurethane foam. Codes require thermal barriers for interiors to reduce the risk of a flash fire and to extend the time at which the foam would reach its auto-ignition temperature should a fire originate from other sources.

The most common fire barrier is the placement of one ⅝ inch gypsum wallboard or drywall over the polyurethane foam. Alternatively, prefabricated sandwich panels of gypsum wallboards or gypsum fiber boards with insulating panels made from polyurethane rigid foam are used for internal thermal insulation. The drawback for either method is that the addition of a gypsum wallboard or the construction of a sandwich panel significantly increases the materials and associated labor due to the weight and handling required for interior insulation using polyurethane foam.

Other alternatives that have been used include the incorporation of intumescent material into the polyurethane mixture or the coating of the polyurethane foam with spray-applied fire-resistive materials (SFRM). Both techniques have disadvantages. The friable nature of SFRMs makes them unsuitable for application in an area that receives direct contact, vibrations or foot traffic. Additionally, it is not suitable for some areas due to space limitations because of the thickness and is not considered to be aesthetically pleasing for many exposed indoor environments.

Intumescent materials can expand from 5 to 100 times their original thickness or dry-film thickness, but typically, these coatings will expand anywhere from 15 to 30 times their original thickness when exposed to a fire. When exposed to the heat from a fire at approximately 204° C. (400° F.), intumescent coatings begin to melt and blowing agents decompose to foam the molten ingredients. The coatings burn, expand, pyrolize and degrade to carbon based char and insulate the substrate from fire. The incorporation of intumescent material into the polyurethane mixture is not as effective because the thermal barrier is positioned throughout the foam as opposed to directly on the surface of the foam, at the point of the fire. Additionally, the presence of intumescent material within the foam mixture makes the application of the foam difficult.

Intumescent fire-resistant coatings are paint-like coatings with intumescent properties. However, they are typically applied to structural steel members, and not combustible material. The final thickness of these coatings typically ranges from 0.03 inches to 0.50 inches. The coatings are designed to provide insulation to the steel members in the event of a fire. Their function is identical to other more traditional materials such as gypsum wall board and coatings categorized as spray-applied fire resistant materials.

A thermal barrier that can be applied simply and effectively to a combustible substrate such as polyurethane foam is needed. Additionally, it would be desirable to have a thermal barrier that is not friable and is aesthetically pleasing. Finally, it would be desirable to have a thermal barrier that can be spray applied over a combustible substrate and meets industry standards such as FM Approval Standard Class Number 4975, or ULC CAN4-S124M, UL 1715 (Room fire test). UBC 26-3, UBC 26-2, or ASTM E 84, all of which are incorporated herein by reference.

### SUMMARY OF THE INVENTION

A method of providing a thermal barrier between a fire and a combustible substrate is provided. The method comprises the step of applying at least one coat of thin-film intumescent coating to the surface of the combustible substrate. The coating may be applied to the surface of the foam by any conventional means such as rolling or brushing, but is preferably spray applied with an airless sprayer. The thin-film intumescent coating is preferably fire-resistive and may be solvent based but is preferably water based and preferably comprises polyvinyl acetate resins and inorganic fillers. The coating is typically applied range from 1-500 mils thick. In one embodiment the combustible substrate is foam insulation. Preferably the foam insulation is spray-applied rigid polyurethane foam with a density in the range of 1.8-3.2 lbs, or polyisonene with a density of 0.5-1.5 lbs per cubic foot.

In another aspect, a method of providing a 15 minute thermal barrier to foam insulation is provided. The method comprises the step of applying at least one coat of thin-film intumescent coating to the surface of the foam, which is preferably either polyurethane or polyisonene. Optionally more than one coat can be applied to reach the desired thickness. Additionally, the method also includes the optional step applying a finish coat to the dried intumescent coating.

### DETAILED DESCRIPTION

The present invention provides a method for providing a thermal barrier between a fire and a combustible surface or substrate. In one embodiment the method comprises applying at least one coat of a thin-film intumescent coating to the surface of a foam insulation, and preferably polyurethane foam. Hereinafter any reference to intumescent coating or paint refers to thin-film fire-resistive intumescent coating unless otherwise indicated. The intumescent coating is applied directly to the combustible surface or substrate.

New water-based intumescent coatings are design-tested and have the necessary reinforcement to produce a dense char with exceptional structural integrity in longer fires. Additionally, the new generation water-based systems have higher solids-by-volume formulations to reduce shrinkage during drying and can be applied at greater thickness with fewer coats, which dramatically reduces installation costs. Water-based coatings are also more viscous, but can still be applied with small portable electric airless equipment and small diameter hoses.

Thin-film intumescent coating has primarily been used for application on structural steel and has never been used, as disclosed in the present invention, directly on the surface of combustible surfaces or substrates. When used on structural steel, a primer must first be applied to the steel. After the primer is applied the intumescent coating is applied on top of the primer and can be brushed, rolled or spray applied with airless paint equipment. An additional finish coat is then typically applied in the desired color directly over the intumescent coating.

In the present invention, the thin-film fire-resistive intumescent coating can be solvent-based or water-based and can be applied directly to the surface of the combustible material without the use of a primer. Whenever possible, water based intumescent coatings are preferred over volatile solvent-based products in most applications. Many water-based products have also passed Underwriters Laboratories (UL) interior general purpose and exterior use requirements without the adhesive basecoats or mechanical mesh reinforcement required with use of many solvent-based products. These water based systems can be applied at higher thickness per coat, which expedites the overall process. Unlike many solvent-based products, water-based products offer more topcoating options. Decorative latex, acrylic latex, alkyd, or silicone alkyd topcoats may be applied for a complete range of color, gloss and texture finishes. More preferably, the coating is CAFO SprayFilm®-WB2, WB3, WB4. Such coatings are water-based intumescent coatings consisting of polyvinyl acetate resins and inorganic fillers. Nonetheless, solvent based products are acceptable may be used in the method of the present invention

The application of the coating to the surface of the combustible substrate can be accomplished through any conventional means of applying such coatings. No primer is required which offers a substantial benefit over conventional techniques. For example, the coatings can be brushed, rolled or spray-applied with airless paint equipment. Preferably the coating is spray-applied. The thickness of the coating will depend upon the specific application. For example, specified fire rating and size/shape of a polyurethane foam member to be protected will be factors in determining the requisite thickness. Generally the thickness will be in the range from as little as about 3 mils to 500 mils or more. In most applications, the thickness is less than 100 mils and more preferably, thickness is applied to about 30 mils.

The type of substrate can be the surface of any combustible material. Nonlimiting examples include natural wood or manufactured lumber, which is a wood that is combined with combustible adhesives such as a blue laminated beam, for example. Other examples include oriented strandboard, commonly called OSB, and other materials like gypsum wallboard or even something that is only slightly combustible. In a preferred embodiment, the type of combustible material is insulating foam. Examples of such foam include polyisonene and more preferably polyurethane foam. Any insulating foam that requires a thermal barrier and can both adhere to an intumescent coating and support the char as discussed below is a suitable foam substrate. Those skilled in the art will be able to choose an appropriate foam depending on the requirements of the application.

The polyurethane foam may be rigid and/or spray applied and typically has a density range of 1.8-3.2 lbs per cubic foot. Similarly, the polyisonene may also be rigid and/or spray applied and typically has a density of 0.5-1.5 lbs per cubic foot. However, the densities of both types may be outside of these ranges and still be suitable for use. Both types are typically, but not necessarily, closed-cell spray-on insulation. The polyurethane insulation is commonly used in commercial applications and polyisonene is commonly used for residential applications. In one preferred embodiment, the polyurethane foam is rigid polyurethane foam such as that utilized in insulation applications. Optionally, a finished coat can be applied over the intumescent coating; however, the finished coat is not necessary for the effectiveness of the thermal barrier.

There are a variety of thin-film fire-resistive intumescent coatings that will be effective by the method of the present invention, and the choice of coatings will often be dictated by the specific application. There are a few factors to be considered in choosing the intumescent coating. One factor is the reaction temperature of the intumescent material as compared to the melting temperature of the foam. Specifically, the intumescent material must react at a temperature lower than the melting point of the foam. For example, polyurethane foam will typically start to melt at about 250-300° F. Therefore, the intumescent coating must begin to react at a temperature lower than that melting point. Typical intumescent coatings are going to thermally react or expand and create an insulated barrier at around 400° F. Therefore most intumescent coatings, if not all, will not work at those lower temperatures and thermally react enough to protect the foam at that low temperature.

For the present invention, thin film intumescent coating applied over typical polyurethane foam insulation must thermally react or expand at temperatures less than 250° F., to create an insulated barrier that prevents or slows the foam from reaching the 250 degree critical melting point for a certain period of time; for example, several industry standards require 15 minutes of protection. The preferred coating is thin film intumescent fire-resistive coating, and more preferably CAFCO SprayFilm®-TB 15.

Another factor to be considered is the adhesion of the intumescent coating to the foam. In this regard, a coating must be chosen that will adhere to the foam under ambient conditions. Additionally, the density of the char that results from the reaction is also a consideration. The coating must expand to a degree that it insulates the foam from the fire or heat, but not so much that it ablates or flakes off of the foam. For that reason, thin film fire-resistant coatings are generally preferred over fire retardant coatings. If a fire retardant coating is used, it must expand sufficiently and the density of the char must be strong enough to prevent the heat from penetrating the char. Those skilled in the art will be able to choose an appropriate coating with minimal experimentation.

The present invention provides many advantages over traditional thermal barriers. For one example, the need for installation of gypsum board or cement board over the polyurethane foam is eliminated. For another example, the problems associated with the installation and maintenance of SFRMs are also eliminated.

The method of the present invention can be used anywhere polyurethane foam or other combustible substrates are used. Non-limiting examples include the interior of structures such as airplane hangars and even grocery stores, as many of the intumescent coatings have the additional benefit of being mold resistant. Another example is the use on aviation applications generally in places where combustible materials require a thermal barrier protection. Specific aviation application includes the application when polyurethane or combustible substrates are used on the interior parts of aircraft cavities to provide insulation of those cavities. In such an instance, thin film intumescent coating applied over the substrates provides a barrier for a certain period of time.

The method of the current invention can performed in compliance with many applicable industry standards including UL723-ASTM E84 entitled Test for Surface Burning Characteristics of Building Materials, and its comparable test Underwriters Laboratories Inc. (UL) #1040; Factory Mutual (FM) #4880 entitled Approval Standard for Class 1 Fire Rating of Insulated Wall or Wall and Roof/Ceiling Panels, Interior Finish Materials or Coatings, Exterior Wall Systems; Underwriters Laboratories of Canada Thermal barrier Components; ICBO-ICC International Building Code Section 26.03.4; FM Approval Standard Class Number 4975, or ULC CAN4-S124M, UL 1715 (Room fire test). UBC 26-3 and UBC 26-2; each of which are incorporated herein by reference.

For example, the method may be applied so that foam shall be separated from the interior of a building by an approved thermal barrier that will limit the average temperature rise of the unexposed surface to not more than 250° F. after 15 minutes of fire exposure in compliance with ICBO-ICC International Building Code Section 26.03.4. For another example, the method can be applied so that a protective covering and the foam at the end of 15 minutes of a fire does not exceed 140° C. average or 180° C. at any one thermocouple in accordance with Classification A of Underwriters Laboratories of Canada Thermal barrier Components. For another example the method of the current invention can be applied in accordance with Factory Mutual (FM) #4880 to qualify as Class 1 fire rated insulated wall or wall and roof/ceiling panels, interior finish materials or coatings, or exterior wall systems, with height restrictions.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims, is reserved.

The following test example serves to further typify the nature of the invention, but should not be construed as a limitation on the scope thereof, which is defined solely by the appended claims.

### TEST EXAMPLE

Test material: CAFCO SprayFilm®-TB 15 was applied at a nominal thickness of 30 mils over spray applied 2 pcf closed cell spray applied polyurethane foam.

### Test Performed:

The material was tested for surface burning characteristics in accordance with the procedures outlined in ASTM E84-05. The test also included Material Identification, Method of Preparation, Mounting and Conditioning of the specimens.

### Introduction:

This test provided results of Flame Spread and Smoke Developed Values per ASTM E-84-05.

The tests were performed in accordance with the specifications set forth in ASTM E-84-05, Standard Test Method for Surface Burning Characteristics of Building Materials, both as to equipment and test procedure. This test procedure is similar to UL-723, ANSI No. 2.5, NFPA No. 255 and UBC 42-1.

The test results cover two parameters: Flame Spread and Smoke Developed Values during a 10-minute fire exposure. Inorganic cement board and red oak flooring are used as comparative standards and their responses are assigned arbitrary values of 0 and 100, respectively. The test is predictive of how similarly prepared materials would perform in such industry standards as FM 4975.

### Preparation and Conditioning:

The test material consisted of five pieces. The pieces were placed into the fire test chamber end to end, with the SprayFilm®-TB 15 facing down, to form a 21 inch wide×24 foot long specimen for testing. Inorganic cement boards were placed over the sample prior to testing as a means of protecting the interior of the tunnel lid.

The sample was conditioned at 73°±5° Fahrenheit and 50±5% relative humidity.

### Test Procedure:

The tunnel was thoroughly pre-heated by burning natural gas. When the brick temperature, sensed by a floor thermocouple, had reached the prescribed 105° Fahrenheit±5° level, the sample was inserted in the tunnel and the test conducted in accordance with the standard ASTM E-84-05 procedures.

The operation of the tunnel was checked by performing a 10 minute test with inorganic board on the day of the test.

### Test Results:

The test results, calculated in accordance with ASTM E-84-05 for Flame Spread and Smoke Developed Values are as follows:
Test Specimen: SprayFilm®-TB 15 (a thin film fire-resistive intumescent coating)
Flame Spread Index*: 15
Smoke Developed Value*: 175
Rounded off to the nearest 5 units. Graphs of the Flame Spread, Smoke Developed and Time-Temperature are shown on the attached charts at the end of this report.

### Observations:

Ignition was noted at 40 seconds followed by: Charring, flaking, flaking embers; and slight afterburn.

### Rating:

The National Fire Protection Association Life Safety Code 101, Section 6-5.3, “Interior Wall and Ceiling Finish Classification”, has a means of classifying materials with respect to Flame Spread and Smoke Developed when tested in accordance with NFPA 255, “Method of Test of Surface Burning Characteristics of Building Materials”, (ASTM E-84).

The classifications are as follows:

| | | |
|---|---|---|
| Class A Interior Wall & Ceiling Finish: | Flame Spread- | 0–25 |
| | Smoke Developed- | 0–450 |
| Class B Interior Wall & Ceiling Finish: | Flame Spread- | 26–75 |
| | Smoke Developed- | 0–450 |
| Class C Interior Wall & Ceiling Finish | Flame Spread- | 76–200 |
| | Smoke Developed- | 0–450 |

Since the sample received a Flame Spread of 15 and a Smoke Developed Value of 175, it would fall into the Class A Interior Wall & Ceiling Finish Category.

The results of the Testing Example illustrate the effectiveness of thin-film intumescent as a thermal barrier when applied directly to polyurethane foam. The results indicate one of the most highly combustible insulated materials, (spray-applied polyurethane foam), passes when applied with the coating as described inventive method, as compared to the foam itself which would fail without the coating. The test also indicates that if the coating were applied to other less combustible materials the test numbers will only improve.

The test also illustrated that the coating applied to the foam did thermally react or expand, and that the foam would not just melt. Additionally the test revealed the quality of the long-term adhesion. The thin film fire-resistive intumescent coating product not only maintained the structural integrity of the foam, prevented it from smoking and flaming and throwing a bust of combustibility or fuel source into a fire, it also adhered very well and it expanded at a great rate. The char density was very dense and it prevented any heat from transmitting through the material.

What is claimed is:

1. A method of providing a thermal barrier between a fire and a combustible substrate comprising:
applying at least one coat of thin-film intumescent coating to the surface of the combustible substrate.

2. The method of claim 1 wherein the combustible substrate is a foam comprised of polyurethane or polyisonene.

3. The method of claim 1 wherein the combustible substrate is spray applied polyurethane foam.

4. The method of claim 1 wherein the intumescent coating is spray-applied with an airless sprayer.

5. The method of claim 1 wherein the thin-film intumescent coating is water based.

6. The method of claim 1 wherein the thin-film intumescent coating is applied in a thickness range from 1-500 mils.

7. The method of claim 3 wherein the water based intumescent coating comprises polyvinyl acetate resins and inorganic fillers.

8. The method of claim 2 wherein the combustible substrate is rigid polyurethane foam with a density in the range of 1.8-3.2 lbs per cubic foot.

9. The method of claim 2 wherein the thin-film intumescent coating is fire-resistive.

10. The method of claim 2 wherein the combustible substrate is spray-applied polyisonene with a density in the range of 0.5-0.5-1.5 lbs per cubic foot.

11. The method of claim 7 further comprising the step of applying a finish coat to the dried intumescent coating.

12. A method of providing a 15 minute thermal barrier to foam insulation comprising: applying at least one coat of thin-film intumescent coating to the surface of foam insulation that is facing the interior of a structure.

13. The method of claim 12 wherein the foam insulation is comprised of polyurethane or polyisonene.

14. The method of claim 13 wherein the foam insulation is spray applied polyurethane foam.

15. The method of claim 14 wherein the thin-film intumescent coating is spray-applied with an airless sprayer.

16. The method of claim 15 wherein the thin-film intumescent coating is water based.

17. The method of claim 16 wherein the thin-film intumescent coating is applied in a thickness range from 1-500 mils.

18. The method of claim 15 wherein the water based intumescent coating comprises polyvinyl acetate resins and inorganic fillers.

19. The method of claim 14 wherein the foam insulation is rigid polyurethane foam with a density in the range of 1.8-3.2 lbs per cubic foot.

20. The method of claim 13 wherein the thin-film intumescent coating is fire-resistive.

21. The method of claim 13 wherein the foam insulation is spray-applied polyisonene with a density in the range of 0.5-0.5-1.5 lbs per cubic foot.
